(19) United States
(12) Patent Application Publication
(10) Pub. No.: US 2024/0000660 A1
(43) Pub. Date: Jan. 4, 2024

(54) PLASTIC CAP

(71) Applicant: DAIKYO SEIKO, LTD., Sano-shi (JP)

(72) Inventor: Takayuki YOSHIDA, Sano-shi (JP)

(73) Assignee: DAIKYO SEIKO, LTD., Sano-shi (JP)

(21) Appl. No.: 18/254,823

(22) PCT Filed: Dec. 25, 2020
(86) PCT No.: PCT/JP2020/048647

§ 371 Date: May 26, 2023

(51) Int. Cl. A61J 1/14; B65D 41/04; A61J 1/06; B65D 41/28; B65D 55/02

(52) U.S. Cl. CPC A61J 1/1412; B65D 41/0442; B65D 2255/20; B65D 41/28; B65D 55/022; A61J 1/065

(57) ABSTRACT

To provide a plastic cap that can be safely applied to a closed system drug transfer device, prevents the leakage of a drug from a pharmaceutical container, and does not require a plurality of connection adapters when fitting to a medical instrument of the closed system drug transfer device.

There is provided a plastic cap attached to a pharmaceutical container and fitting to a medical instrument used for a closed system drug transfer device, the cap includes a top surface part having a fitting part at the center thereof, a cylindrical skirt part extending downward from an outer periphery of the top surface part and opening at a lower end, and a fitting member fitting inside the skirt part, in which the fitting part includes a lip and an intermediate tube extending downward from the lip, and the skirt part has a lower rubber stopper there inside and the lower rubber stopper has an O-ring shape.

### TECHNICAL FIELD

The present invention relates to a plastic cap. More specifically, the present invention relates to a plastic cap that can be safely applied to a closed system drug transfer device, prevents the leakage of a drug from a pharmaceutical container, and does not require a plurality of connection adapters when fitting to a medical instrument of the closed system drug transfer device.

### BACKGROUND ART

Pharmaceutical containers such as a vial are widely used as storage containers for various drugs including pharmaceutical products in related art. The pharmaceutical container is used in a state where, after the drug is stored, a mouth part of the pharmaceutical container is sealed with a rubber stopper to make the interior of the pharmaceutical container hermetically sealed. The drug stored in the pharmaceutical container is transferred by a user such as a healthcare worker by using a liquid drug transfer device or the like described in, for example, Patent Literature 1. When the drug stored in the pharmaceutical container is particularly an anticancer drug, it is necessary to use, in general, a Closed System Drug Transfer Device (CSTD) for preventing exposure to the user due to the leakage or the like of aerosol, vapor, and liquid from the interior of the pharmaceutical container.

On the other hand, the pharmaceutical container is used in a state where, after the drug is stored, a mouth part of the pharmaceutical container is sealed with a rubber stopper to make the interior of the pharmaceutical container hermetically sealed. Furthermore, as the rubber stopper may come off from the pharmaceutical container when treatment such as heat sterilization is performed to the pharmaceutical container, it is common to fit an aluminum cap or a plastic cap to the pharmaceutical container so as to extend to a lower part of a lip of the mouth part of the pharmaceutical container in a manner of wrapping the rubber stopper in order to prevent the rubber stopper that caps the mouth part of the pharmaceutical container from coming off and secure hermeticity in the pharmaceutical container. The aluminum cap widely used in related art is swaged at the lower part of the lip of the mouth part of the pharmaceutical container by excellent deformability of aluminum, thereby exhibiting an excellent property of preventing coming-off of the rubber stopper. However, loading operation and the like of the drug are often performed in a clean room in recent years. There are problems that aluminum fine particles are generated and dispersed due to the collision of caps with each other and the like at the time of manufacturing or using the drug and that sorted disposal of aluminum after use is difficult; therefore, there is a tendency to hesitate to use the aluminum cap recently.

For this reason, the use of the plastic cap is increasing. Meanwhile, drugs stored in the pharmaceutical container are highly diversified, that is, for example, lyophilization treatment is performed to the drug in the pharmaceutical container and sealed after that. Therefore, various plastic caps which have high workability with many functions by devising the shape thereof have been proposed in recent years (see Patent Literatures 2, 3). However, there is a problem that the plastic cap is inferior to the aluminum cap in engagement with the pharmaceutical container when compared with the aluminum cap. This is because the plastic cap is formed by providing claws for engagement inside the cap and engaging the claws with the lip of the mouth part of the pharmaceutical container to thereby fix the cap, which differs from the aluminum cap in which aluminum is freely deformed along the lip of the mouth part of the pharmaceutical container and the cap is swaged at the mouth part of the pharmaceutical container easily and firmly.

For this reason, the cap easily comes off from the pharmaceutical container when the engagement between the pharmaceutical container and the plastic cap is loose. On the other hand, it becomes difficult to perform capping itself when the engagement between the pharmaceutical container and the cap is too firm; therefore, high dimensional accuracy is required for both the cap and the pharmaceutical container in the case of the plastic cap. Concerning the above, when both the cap and the pharmaceutical container are made of synthetic resin, it is possible to increase the dimensional accuracy of both components because shrinkage deformation at the time of cooling can be calculated to mold the components into predetermined shapes. However, a dimensional error in a pharmaceutical container made of glass is one digit higher than that of the pharmaceutical container made of synthetic resin; therefore, there is a problem that it is difficult to sufficiently prevent coming-off of the cap even when the dimensional accuracy of the plastic cap is increased. The present applicant has already proposed, in response to the above problems, an inner shape of the plastic cap for the pharmaceutical container capable of securing tightness of the rubber stopper that caps the mouth part of the pharmaceutical container not only in the case of the pharmaceutical container made of synthetic resin but also in the case of the pharmaceutical container made of glass that is inferior to the pharmaceutical container made of synthetic resin in dimensional accuracy (see Patent Literature 4). The cap has a structure in which an inner diameter of a skirt part is formed greater than an outer diameter of a lip of the pharmaceutical container and a plurality of ribs are formed on an inner surface of the skirt part in a direction perpendicular to a top surface part to thereby absorb a dimensional error.

As shown in Patent Literature 5, in a telescopic female drug vial adapter, the drug vial adapter matches with a drug vial in a lower part of the adapter. An upper part of the adapter has a standing female connector for joining to a needleless syringe. Therefore, there is a problem that a plurality of connection adapters are necessary for fitting to a medical instrument used for the closed system drug transfer device (including a closed system connection instrument and the like) not only on the drug vial side in the lower part of the adapter but also at the upper part of the adapter (see Patent Literature 5).

### CITATION LIST

### Patent Literature

PTL 1: JP2009-504230A
PTL 2: JP2007-217007A
PTL 3: JP3487748B
PTL 4: JP2009-137641A
PTL 5: JP2015-528368A

### SUMMARY OF INVENTION

### Technical Problem

When the drug transfer device or the like does not match with the pharmaceutical container, it becomes difficult to puncture the rubber stopper that caps the mouth part of the pharmaceutical container, and there is a danger of causing an accident such as the leakage of the drug from the pharmaceutical container in some cases. Since the aluminum cap has the problems as described above on the other hand, a plastic cap capable of holding the rubber stopper that caps the mouth part of the pharmaceutical container is required. Further development of the plastic cap has been desired under such circumstances.

Accordingly, the present invention provides a plastic cap that can be safely applied to the closed system drug transfer device, prevents the leakage of the drug from the pharmaceutical container, and does not require a plurality of connection adapters when fitting to a medical instrument of the closed system drug transfer device.

### Solution to Problem

That is, the present invention provides a plastic cap (F) attached to a pharmaceutical container (A) and fitting to a medical instrument used for a closed system drug transfer device, the cap (F) includes
a top surface part (F1) having a fitting part (F11) at the center thereof, a cylindrical skirt part (F2) extending downward from an outer periphery of the top surface part (F1) and opening at a lower end, and a fitting member (F3) fitting inside the skirt part (F2),
in which the fitting part (F11) includes a lip (F112) and an intermediate tube (F113) extending downward from the lip (F112), and
the skirt part (F2) has a lower rubber stopper (F211) thereinside and the lower rubber stopper (F211) has an O-ring shape.

In the present invention, the lower rubber stopper (F211) may be convex toward an upper direction.

In the present invention, the fitting part (F11) may include an upper surface (F115), an upper rubber stopper (F111), and a lower surface (F114) in the lip (F112), and a contact surface with respect to the medical instrument may contact at least one place in the lower surface (F114) or the upper surface (F115) of the fitting part (F11).

In the present invention, the fitting member (F3) may include a locking claw (F32) on an inner side for engaging with a lip (A2) of the pharmaceutical container (A).

In the present invention, a plurality of locking claws (F31) may be provided on an outer peripheral surface of the fitting member (F3).

In the present invention, a concave portion (F33) for temporarily engaging with the skirt part (F2) may be provided on the outer peripheral surface of the fitting member (F3), and a convex portion (F23) may be provided on an opening side of the skirt part (F2).

In the present invention, when a force used when the convex portion (F23) climbs over the locking claw (F31) is set as a force f3, the force f3 may be larger than a force f2 used when the locking claw (F32) climbs over the lip (A2) until reaching a lower surface from an upper surface via a side surface.

### Advantageous Effects of Invention

According to the present invention, it is possible to provide a plastic cap that can be safely applied to the closed system drug transfer device, prevents the leakage of the drug from the pharmaceutical container, and does not require a plurality of connection adapters when fitting to a medical instrument of the closed system drug transfer device.

Note that the effects described here are not always limited to the above, and may be some of effects described in the specification.

### BRIEF DESCRIPTION OF DRAWINGS

FIG. 1 is a view illustrating an example of an embodiment of a cap F according to the present invention.

FIG. 2 is view illustrating an example of the embodiment of the cap F according to the present invention, which is applied to a pharmaceutical container A in a half-capped state.

FIG. 3 is a view illustrating an example of the embodiment of the cap F according to the prevent invention, which is applied to the pharmaceutical container A in a full-capped state.

FIG. 4 is a perspective view of an example of the embodiment of the cap F according to the present invention, which is seen from the above.

FIG. 5 is a perspective view of an example of the embodiment of the cap F according to the present invention, which is seen from the bottom.

FIG. 6 is a perspective view of an example of an embodiment of a fitting member F3 in the cap F according to the present invention, which is seen from the above.

### DESCRIPTION OF EMBODIMENTS

Hereinafter, preferred embodiments of the present invention will be explained.

Embodiments described below are examples of a representative embodiment of the present invention, and the scope of the present invention should not be narrowly interpreted based on these examples.

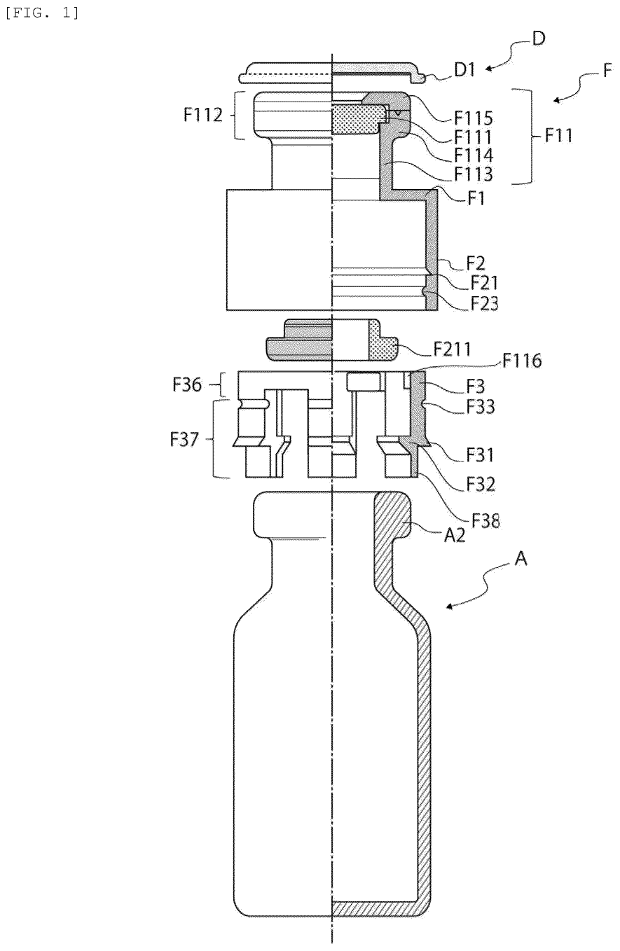

FIG. 1 is a view illustrating an example of an embodiment of a plastic cap F according to the present invention.

The plastic cap F according to the present invention is a cap attached to a pharmaceutical container A, fitting to a medical instrument used in a Closed System Drug Transfer Device (CSTD), and capable of being applied to the CSTD.

Here, the definition of the Closed System Drug Transfer Device (CSTD) will be explained. The closed system drug transfer device may indicate two items which are a closed system connection instrument (not illustrated) and a closed system dosing route; however, the former closed system connection instrument is mainly indicated in the present description.

The cap F includes a top surface part F1 having a fitting part F11 at the center thereof, a cylindrical skirt part F2 extending downward from an outer periphery of the top surface part F1 and opening at a lower end, and a fitting member F3 fitting inside the skirt part F2. The fitting part F11 has a lip F112 and an intermediate tube F113 extending downward from the lip F112, and the fitting part F11 fits to the medical instrument which is the closed system connection instrument. Note that a vial adapter having a common needle portion is cited as the medical instrument.

The fitting part F11 includes an upper rubber stopper F111 having a convex shape toward a lower direction for preventing exposure inside the lip F112 and a lower rubber stopper F211 having a convex shape toward an upper direction at a lower end of the intermediate tube F113 and at an opening of the skirt part F2. The lower rubber stopper F211 has an O-ring shape.

The needle portion of the closed system connection instrument or the like can be stuck to the upper rubber stopper F111.

Next, how the closed system connection instrument fits to the fitting part F11 of the cap F according to the present invention will be explained.

When the vial adapter (not illustrated) which is the closed system connection instrument has a housing, the vial adapter provided with a spike needle fits to the fitting part F11 from an upper surface and contacts at least one place in a lower surface F114 or an upper surface F115 that form an outer edge portion of the lip F112 inside the housing. Therefore, a plurality of vial adapters are not necessary when attaching the closed system connection instrument to the fitting part F11.

The skirt part F2 includes a fitting member F3 provided with at least two or more locking claws F32 having a reverse-L shape thereinside, which is used when fitting to a lip A2 of a pharmaceutical container A. In addition, the fitting member F3 and the lower rubber stopper F211 contact the lip A2 to be in a fitted state. Note that the fitting member F3 and the lower rubber stopper F211 do not contact with each other. That is because a capping pressure is increased when these components contact with each other.

According to the above, even when the pharmaceutical container A is not capped with the rubber stopper (not illustrated), the drug can be transferred while keeping airtightness of the container, and aseptic properties inside the pharmaceutical container A can be maintained while preventing exposure due to the leakage or the like of aerosol, vapor, and liquid from the interior of the pharmaceutical container A; therefore, safe application to the closed system drug transfer device can be realized. In addition, the lower rubber stopper F211 has the O-ring shape; therefore, when the upper surface of the upper rubber stopper F111 is punctured, it is possible to prevent that a needle tip does not reach the drug and drug cannot be aspirated.

In the present invention, the lower rubber stopper F211 having the O-ring shape is convex toward an upper direction of the intermediate tube F113. Therefore, the lower rubber stopper F211 contacts an inner wall surface of the skirt part F2 of the cap F, which can prevent the lower rubber stopper F211 from falling off.

In the present invention, the fitting part F11 has an approximately T-shape and includes the upper surface F115, the upper rubber stopper F111, and the lower surface F114 in the lip F112, in which a contact surface with respect to the medical instrument contacts at least one place in the upper surface F115 or the lower surface F114. Therefore, the cap F according to the present invention can be fitted to the medical instrument used for the CSTD more positively.

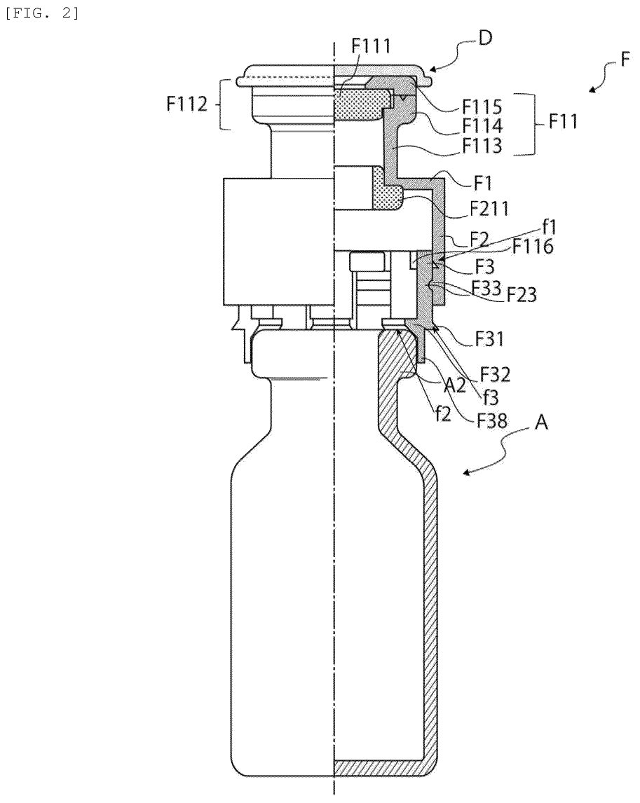

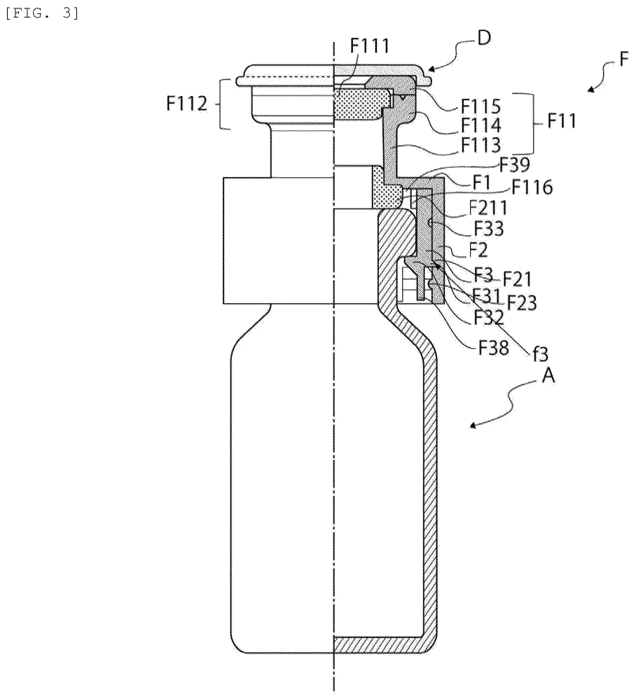

Next, a half-capped state on the pharmaceutical container A will be explained as an example of the embodiment of the cap F according to the present invention in FIG. 2, and a full-capped state on the pharmaceutical container A will be explained as an example of the embodiment of the cap F according to the present invention in FIG. 3.

As illustrated in FIG. 2, the cap F can be held in a half-capped state on the pharmaceutical container A by the fitting member F3 provided in the skirt part F2 of the cap F in the present invention. The half-capped state is a state where the lower rubber stopper F211 is separated from the lip A2 of the pharmaceutical container A. A concave portion F33 of the fitting member F3 is fitted to a convex portion F23 provided inside the skirt part F2, and part of the locking claw F32 contacts an upper surface of the lip A2. The half-capped state also indicates a state where the plastic cap F is temporarily fixed to the lip A2 of the pharmaceutical container A, and the interior of the pharmaceutical container A communicates with outside air through a space (gap) between the lip A2 and the lowermost surface of the skirt part F2.

FIG. 3 illustrates a state where the skirt part F2 of the cap F is fully capped on the pharmaceutical container A by the fitting member F3. The full-capped state is a state where the lower rubber stopper F211 contacts the lip A2 of the pharmaceutical container A. The full-capped state also indicates a state where a locking claw F31 provided on an outer side of the fitting member F3 is fitted to a concave portion F21 provided inside the skirt part F2, and the locking claw F32 contacting the upper surface of the lip A2 slides on a side surface of the lip A2 to be locked on a lower surface of the lip A2.

When the full capping is executed, as illustrated in FIG. 3, the plastic cap F is in a state of being locked with the lip A2 of the pharmaceutical container A, the lip A2 contacts the lower rubber stopper F211, and the space (gap) above the lip A2 is blocked; therefore, the interior of the pharmaceutical container A does not communicate with outside air.

Consequently, the cap F according to the present invention is extremely effective, for example, in a case where the drug loaded in the pharmaceutical container A is lyophilized. When using the cap F according to the present invention, for example, gas generated in the pharmaceutical container A in a lyophilization process can be exhausted quickly along the space (gap) existing in the lip A2, and, at the same time, the rubber stopper can be capped extremely quickly by using a capping machine or the like after the lyophilization is completed as illustrated in FIG. 3. Therefore, the airtightness inside the pharmaceutical container A can be secured.

Next, the relationship of forces (forces f1 to f3) for climbing over respective members will be explained as an example from FIG. 2 onward by focusing on a motion for covering the fitting member F3 by the skirt part F2.

When a force used when the convex portion F23 provided in the skirt part F2 climbs over the concave portion F33 provided on an outer peripheral surface of the fitting member F3 is set as a force f1, and a force used when the locking claw F32 climbs over the lip A2 is set as a force f2, the relationship holds: the force f2> the force f1. A step in which the convex portion F23 provided in the skirt part F2 climbs over the concave portion F33 will be referred to as a first locking step.

Next, as illustrated in FIG. 3, when a force used when the convex portion F23 provided in the skirt part F2 climbs over the locking claw F31 provided on the outer peripheral surface of the fitting member F3 is set as a force f3, the force f3 is larger than the force f2 used when the locking claw F32 climbs over the lip A2 until reaching the lower surface from the upper surface via the side surface, as a result, the following relationship holds: the force f3>the force f2. A step in which the convex portion F23 climbs over the locking claw F31 provided on the outer peripheral surface of the fitting member F3 will be referred to as a second locking step.

The skirt part F2 and the fitting member F3 have the relationship of the force f3> the force f2> the force f1; however, the relationship between the force f1 and the force f2 is not particularly limited in the present invention. The force f3 used when the convex portion F23 provided in the skirt part F2 climbs over the locking claw F31 provided on the outer peripheral surface of the fitting member F3 may simply need to be larger than the force f2 used when the locking claw F32 provided inside the fitting member F3 climbs over the lip A2, that is, the following relationship may simply need to hold: the force f3> the force f2. Therefore, the skirt part F2 and the fitting member F3 may have the relationship of the force f3> the force f1> the force f2 in the present invention.

Note that “the locking claw F32 climbs over the lip A2” means that the locking claw F32 placed on the upper surface of the lip A2 moves from the side surface of the lip A2 along the lower surface of the lip A2. When the locking claw F32 moves to the lower surface of the lip A2, the convex portion F23 climbs over the locking claw F31 provided on the outer peripheral surface of the fitting member F3, and the locking claw F31 fits to the concave portion F21, the full-capped state can be obtained. Accordingly, the skirt part F2 covers from the outside of the fitting member F3 through the first locking step and the second locking step to be in the full-capped state that is a more-firmly fitted state; therefore, safe application to the closed system drug transfer device can be realized, and the leakage of the drug from the pharmaceutical container A can be prevented.

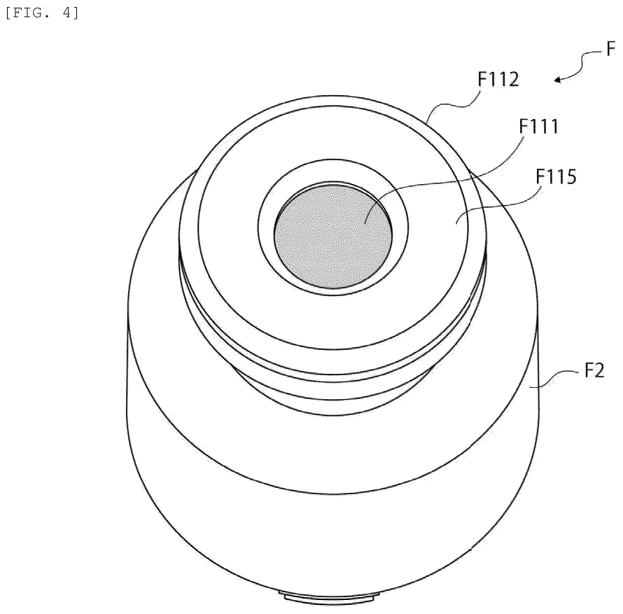

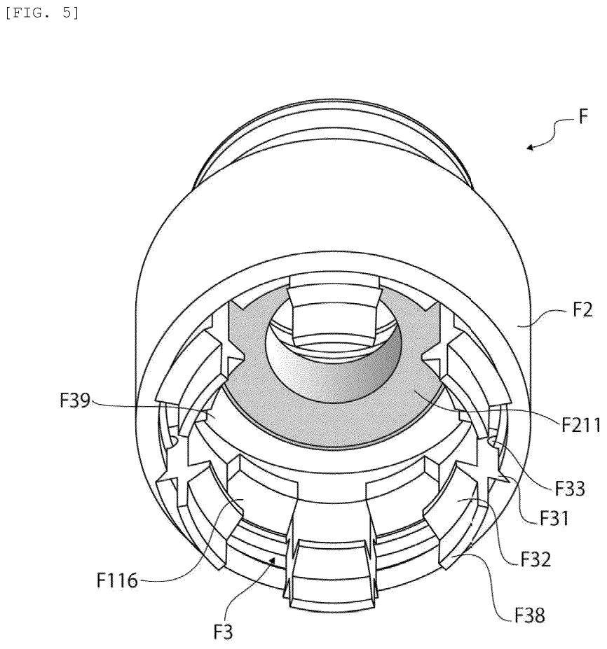

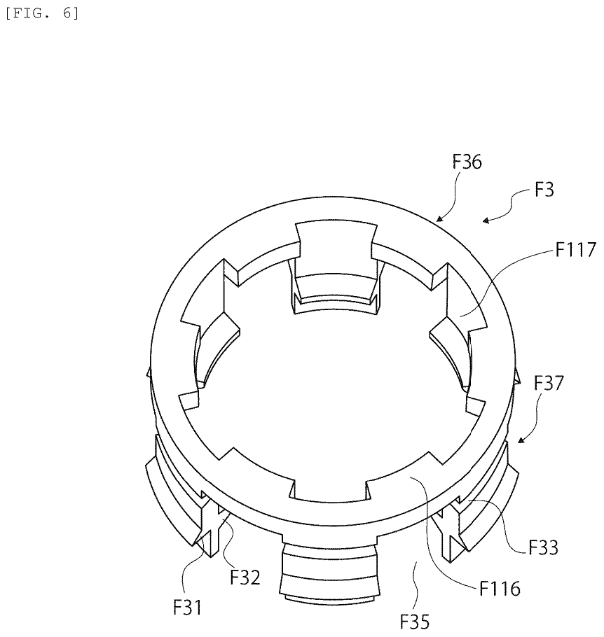

FIG. 4 is a perspective view of an example of the embodiment of the cap F according to the present invention, which is seen from the above, FIG. 5 is a perspective view of an example of the embodiment of the cap F according to the present invention, which is seen from the bottom, FIG. 6 is a perspective view of an example of an embodiment of a fitting member F3 in the cap F according to the present invention, which is seen from the above.

As illustrated in FIG. 3 and FIG. 4, an outer diameter of the skirt part F2 is larger than outer diameters of the lip F112 and the intermediate tube F113. When the outer diameter of the lip F112 is compared with the outer diameter of the intermediate tube F113, the outer diameter of the lip F112 is larger than the outer diameter of the intermediate tube F113.

In the present invention, a plurality of locking claws F31 are provided on the outer peripheral surface of the fitting member F3. The locking claw F31 can be formed, for example, in a convex shape extending in an outer diameter direction. According to the above, even when a force toward an upper direction is added to the cap F in the full-capped state, it is possible to prevent the skirt part F2 and the fitting member F3 from being separated.

In FIG. 5, the plural locking claws F31 are provided on the outer peripheral surface of the fitting member F3, a plurality of locking claws F32 are provided on an inner side, and a tip member F38 having a wall surface shape and curved in a rectangular shape is provided between each of the locking claws F31 and each of the locking claws F32. Providing the tip members F38 prevents the locking claws F31 and the locking claws F32 from being damaged as well as serves as a guide for the lip A2.

As illustrated in FIG. 6, the fitting member F3 is composed of a ring-shaped member F36 and a plurality of leg portions F37 provided by extending the ring-shaped member F36 downward. The ring-shaped member F36 is provided with a plurality of convex portions F116 and a plurality of concave portions F117 so as to face a center direction of the ring shape when seen from an upper surface. The leg portion F37 is provided by extending the concave portion F117 downward.

As illustrated in FIG. 3 and FIG. 5, the fitting member F3 is provided with the convex portions F116 on the upper surface so as not to touch the lower rubber stopper F211. In this case, a gap F39 is formed between a lower surface of the top surface part F1 that the cap F has and the upper surface of the lip A2. When the lower rubber stopper F211 is pressed and extended in the gap F39, a contact area between the lower rubber stopper F211 and the upper surface of the lip A2 is increased to thereby improve airtightness.

The shape of the plural convex portions F116 and the plural concave portions F117 is not limited, and may be an annular shape with an edge.

The locking claw F32 having a reverse-L shape fitting to the lip A2 of the pharmaceutical container A is provided on an inner side of the leg portion F37. Moreover, the locking claw F31 having an L-shape contacting the inner wall surface of the skirt part F2, and the concave portion F33 for temporarily engagement are provided on an outer side of the leg portion F37. The locking claw F32 provided on the inner side of the leg portion F37 is thicker than the locking claw F31 provided on the outer side. This is for preventing damage when fitting to the lip A2 of the pharmaceutical container A. Consequently, the cap F and the pharmaceutical container A can be fixed more firmly in the full-capped state.

In the present invention, at least one or more cutout portions F35 are formed in the fitting member F3. The number of the cutout portions F35 is not particularly limited; but a plurality of cutout portions F35 are preferably formed. Accordingly, it is possible to improve flexibility of the fitting member F3 and to prevent the occurrence of damage such as a crack at the time of fitting the cap F to the pharmaceutical container A.

In order to secure higher hermeticity in the upper rubber stopper F111 and the lower rubber stopper F211 that constitute the plastic cap F according to the present invention, a preferred embodiment will be shown below.

The embodiment explained below is for reference, specifications of which are not limited.

In a case where all of upper and lower surfaces of the upper rubber stopper F111 and the lower rubber stopper F211 are rubber base surfaces, it is preferable that the upper surface of the upper rubber stopper F111 is the rubber base surface, and the lower surface of the upper rubber stopper F111 is made by laminating a plastic film without applying a lubricant such as silicone.

In a case where the upper surface of the upper rubber stopper F111 is the rubber base surface, and if slipperiness is necessary on a top surface of the upper rubber stopper F111, a plastic film can be laminated. General plastic films such as films of polyethylene, polypropylene, and fluorine-based resin can be used as the above plastic film.

A material for forming the plastic cap F according to the present invention is preferably a resin excellent in heat resistance, slipperiness, sterilization resistance, and strength, which includes a thermoplastic resin, a thermoplastic elastomer (TPE), and a polyolefin-based resin; however, the material is not limited to the above, and can be suitably selected. Specifically, for example, the material may be a fluorine-based resin, a polyethylene-based resin, a polypropylene-based resin (PP, including not only a homopolymer but also a copolymer obtained by copolymerizing an ethylene group, a butylene group or the like), a polyester-based resin (PET), a polysulfone-based resin (PSF), a methyl pentene-based resin (PMP), a polyacrylate-based resin (PAR), a polyamide-based resin (PA), a modified polyphenylene oxide resin (m-PPE), a resin containing a cyclic olefin-based compound or a bridged polycyclic hydrocarbon compound as a polymer component, a polycarbonate-based resin (PC), a resin obtained by modifying (grafting) an olefin-based resin using a polar group, polyacetal (POM) that is also excellent in wear resistance, flexible polyvinyl chloride (flexible PVC), thermoplastic polyurethane (TPU), and the like.

The cap F and the fitting member F3 may be formed of the same material or formed of different materials. The materials are not limited to the above as long as the material does not have a problem in conditions for autoclave sterilization, which are, for example, heat resistance for withstanding 121° C. and 20 minutes, or a problem in strength such as deterioration and a crack, and the material can be sterilized by radiation sterilization and the like. When the cap F according to the present invention is formed of plastic, fine particles are not generated even when the caps are rubbed against each other or collided with each other. Additionally, the cap F can be manufactured by, for example, injection molding; therefore, the degree of freedom in shape and structure is high.

Materials for forming the upper rubber stopper F111 and the lower rubber stopper F211 may be synthetic rubbers such as a butyl rubber, an isoprene rubber, a butadiene rubber, a halogenated butyl rubber, ethylene-propylene terpolymer, and a silicone rubber or compounds of natural rubber. As the fluorine-based resin for lamination, for example, a tetrafluoroethylene resin, a chlorotrifluoroethylene resin, a tetrafluoroethylene-hexafluoropropylene copolymer resin, a vinylidene fluoride resin, a vinyl fluoride resin, a tetrafluoroethylene-ethylene copolymer resin, a chlorotrifluoroethylene-ethylene copolymer resin, and the like can be used.

In the cap F according to the present invention, a cover D which is removable by fingers may be integrally provided on the upper surface of the lip F112 as illustrated in FIG. 1 to FIG. 3. That is, the cap F and the cover D are respectively molded by, for example, the above-described resin. Although the cover D is not essential in the present invention, the cover D can be provided for preventing contamination on the upper surface of the lip F112 of the cap F. It is preferable that the cover D is provided with one or a plurality of finger hooks D1 formed over the entire circumference or partially formed. A user can put a finger on the finger hook D1 to remove the cover D easily according to need.

As other embodiments of the cover D, formation by a gas impermeable film which is impermeable by gas, water vapor, germs, and the like, or a gas permeable film which is permeable by gas, water vapor, and the like can be cited. It is preferable to apply a method whereby contamination of the lip F112 can be prevented. For example, the cover D may be formed by a seal which can cover the upper surface of the lip F112 of the cap F according to the invention and can be removable therefrom.

A method for using the cap F according to the present invention described above will be explained with reference to FIG. 1 to FIG. 3.

First, a desired drug is loaded in the pharmaceutical container A, then, the cap F is held by the pharmaceutical container A in the half-capped state. In the half-capped state, the skirt part F2 and the fitting member F3 are temporarily fitted through the concave portion F33 and the convex portion F23, and the locking claw F32 inside the fitting member F3 is engaged with the lip A2 of the pharmaceutical container A. Subsequently, the pharmaceutical container A is lyophilized and sealed by using the capping machine or the like after the lyophilization is completed. At this time, the plurality of locking claws F32 are elastically deformed and move downward while touching the outer peripheral surface of the lip A2 as the cap F moves downward. When tips of the convex locking claws F32 pass the outer peripheral surface of the lip A2, the locking claws F32 are returned to the original state and fixed to the pharmaceutical container A. At the same time as the above, an upper part of the fitting member F3 enters the inside of the skirt part F2 and the plurality of locking claws F31 are elastically deformed to thereby fit the fitting member F3 to the skirt part F2 firmly. Subsequently, the user punctures the upper rubber stopper F111 from the upper surface F115 side by using the medical instrument used for the CSTD and transfers the drug.

In the above described example, after the cap F is fitted to an opening of the pharmaceutical container A so as to make the pharmaceutical container A hermetically sealed, the cap F is fitted by using the capping machine or the like; however, the present invention is not limited to this.

### INDUSTRIAL APPLICABILITY

As apparent from the above, according to the present invention, the cap according to the present invention contacts the lip of the pharmaceutical container to be in the fitted state by the fitting member and the lower rubber stopper included in the present invention; therefore, it is possible to provide a plastic adapter in which the drug can be transferred while keeping the airtightness even when the pharmaceutical container is not capped with the rubber stopper, aseptic properties inside the pharmaceutical container can be maintained while preventing exposure due to the leakage or the like of aerosol, vapor, and liquid from the interior of the pharmaceutical container, safe application to the closed system drug transfer device can be realized, and further, a plurality of connection adapters are not necessary when fitting to a medical instrument of the closed system drug transfer device.

### REFERENCE SIGNS LIST

A: pharmaceutical container
A2: lip
D: cover
D1: finger hook
F: plastic cap
F1: top surface part
F11: fitting part
F111: upper rubber stopper
F112: lip
F113: intermediate tube
F114: lower surface
F115: upper surface
F116: convex portion
F117: concave portion
F2: skirt part
F21: concave portion
F23: convex portion
F211: lower rubber stopper
F3: fitting member
F31: locking claw
F32: locking claw
F33: concave portion
F35: cutout portion
F36: ring-shaped member
F37: leg portion
F38: tip member
F39: gap

1. A plastic cap (F) attached to a pharmaceutical container (A) and fitting to a medical instrument used for a closed system drug transfer device, the cap (F) comprising:
a top surface part (F1) having a fitting part (F11) at the center thereof;
a cylindrical skirt part (F2) extending downward from an outer periphery of the top surface part (F1) and opening at a lower end; and
a fitting member (F3) fitting inside the skirt part (F2),
wherein the fitting part (F11) includes a lip (F112) and an intermediate tube (F113) extending downward from the lip (F112), and
the skirt part (F2) has a lower rubber stopper (F211) there inside and the lower rubber stopper (F211) has an O-ring shape.

2. The plastic cap according to claim 1,
wherein the lower rubber stopper (F211) is convex toward an upper direction.

3. The plastic cap according to claim 1,
wherein the fitting part (F11) includes an upper surface (F115), an upper rubber stopper (F111), and a lower surface (F114) in the lip (F112), and
a contact surface with respect to the medical instrument contacts at least one place in the lower surface (F114) or the upper surface (F115) of the fitting part (F11).

4. The plastic cap according to claim 1,
wherein the fitting member (F3) includes a locking claw (F32) on an inner side for engaging with a lip (A2) of the pharmaceutical container (A).

5. The plastic cap according to claim 4,
wherein a plurality of locking claws (F31) are provided on an outer peripheral surface of the fitting member (F3).

6. The plastic cap according to claim 5,
wherein a concave portion (F33) for temporarily engaging with a skirt part (F2) is provided on the outer peripheral surface of the fitting member (F3), and
a convex portion (F23) is provided on an opening side of the skirt part (F2).

7. The plastic cap according to claim 6,
wherein, when a force used when the convex portion (F23) climbs over the locking claw (F31) is set as a force f3, the force f3 is larger than a force f2 used when the locking claw (F32) climbs over the lip (A2) until reaching a lower surface from an upper surface via a side surface.
